(19) United States
(12) Patent Application Publication
(10) Pub. No.: US 2011/0109617 A1
(43) Pub. Date: May 12, 2011

(54) Visualizing Depth

(75) Inventors: Gregory Nelson Snook, Sammamish, WA (US); Relja Markovic, Seattle, WA (US); Stephen Gilchrist Latta, Seattle, WA (US); Kevin Geisner, Seattle, WA (US)

(73) Assignee: Microsoft Corporation, Redmond, WA (US)

(21) Appl. No.: 12/617,012

(22) Filed: Nov. 12, 2009

(51) Int. Cl. G06T 15/00

(52) U.S. Cl. 345/419

(57) ABSTRACT

An image such as a depth image of a scene may be received, observed, or captured by a device. The image may then be analyzed to identify one or more targets within the scene. When a target is identified, vertices may be generated. A mesh model may then be created by drawing lines that may connect the vertices. Additionally, a depth value may also be calculated for each vertex. The depth values of the vertices may then be used to extrude the mesh model such that the mesh model may represent the target in the three-dimensional virtual world. A colorization scheme, a texture, lighting effects, or the like, may be also applied to the mesh model to convey the depth the virtual object may have in the virtual world.

### BACKGROUND

Many computing applications such as computer games, multimedia applications, or the like use controls to allow users to manipulate game characters or other aspects of an application. Typically such controls are input using, for example, controllers, remotes, keyboards, mice, or the like. Unfortunately, such controls can be difficult to learn, thus creating a barrier between a user and such games and applications. Furthermore, such controls may be different from actual game actions or other application actions for which the controls are used. For example, a game control that causes a game character to swing a baseball bat may not correspond to an actual motion of swinging the baseball bat.

### SUMMARY

Disclosed herein are systems and methods to aid users assist users engaging in a three-dimensional (3D) virtual world by conveying a sense of the depth a virtual object may have in the virtual world. For example, an image, such as a depth image of a scene, may be received or may be observed. The depth image may then be analyzed to identify distinct elements within the scene. A distinct element may be, for example, a wall, a chair, a human target, a controller, or the like. If a distinct element is identified within the scene, then a virtual object, such as an avatar, may be created in the 3D virtual world to represent the orientation of the distinct element in the scene. A visualization scheme may then be used to convey a sense of the depth of the virtual object in the virtual world.

According to an example embodiment, conveying a sense of depth may occur by segregating a selected virtual object from other virtual objects in the scene. After virtual objects have been created in the 3D virtual world, a virtual object may be selected, and the boundaries of the selected virtual object may be determined using the depth map. For example, the depth map may be used to determine that the selected virtual object represents a person, in the scene, that may be standing in front of a wall. When the boundaries of the selected virtual object have been determined, component analysis may be performed to determine connected pixels that may be within the boundaries of the selected virtual object. A colorization scheme, a texture, lighting effects, or the like, may be applied to the connected pixels in order to convey the sense of the depth of the virtual object in the virtual world. For example, the connected pixels may then be colored according to a colorization scheme that represents the depth of the virtual object in the 3D virtual world as determined by the depth map.

In another example embodiment, conveying a sense of depth may occur by placing an orientation cursor on a selected virtual object. A depth image may be analyzed to identify distinct elements within the scene. If a distinct element is identified within the scene, then a virtual object may be created in the 3D virtual world to represent the orientation of the distinct element in the scene. To convey a sense of the depth of the virtual object in the 3D virtual world, an orientation cursor may be placed on the virtual object. The orientation cursor may be a symbol, a shape, color, a text, or the like that may indicate the depth of the virtual object in the virtual world. In one embodiment, several virtual objects may have orientation cursors. When the virtual objects are moved, the size, color, and/or shape of the orientation cursor may change to indicate the location of the virtual object 3D virtual world. In using the size, color, and/or shape of orientation cursors, a user may become aware of the location of a virtual object relative to the location of another virtual object within the 3D virtual world.

In another example embodiment, conveying a sense of depth may occur by the extrusion of a mesh model. A depth image may be analyzed in order to identify distinct elements that may be in the scene. When a distinct element is identified, vertices, based upon the distinct element, may be calculated from the depth image. A mesh model may then be created using the vertices. For each vertex, a depth value may also be calculated such that the depth value may represent, for example, the orientation of the mesh model vertex in the depth field of the 3D virtual world. The depth values of the vertices may then be used to extrude the mesh model such that the mesh model may be used as a virtual object that represents the identified element in the scene in the 3D virtual world. In one example embodiment, a colorization scheme, a texture, lighting effects, or the like, may be applied to the mesh model in order to convey the sense of the depth of the virtual object in the virtual world.

In another example embodiment, conveying a sense of depth may occur by segregating a selected virtual object from other virtual objects in the scene, and extruding a mesh model based on the selected virtual object. After virtual objects have been created in the 3D virtual world, a virtual object may be selected, and the boundaries of the selected virtual object may be determined using the depth map. When the boundaries of the selected virtual object have been determined, vertices, based upon the selected virtual object, may be calculated from the depth image. A mesh model may then be created using the vertices. For each vertex, a depth value may also be calculated such that the depth value may represent, for example, the orientation of the mesh model vertex in the depth field of the 3D virtual world. The depth values of the vertices may then be used to extrude the mesh model such that the mesh model may be used as a virtual object that represents the identified element in the scene in the 3D virtual world. In one example embodiment, the depth values of the vertices may be used to extrude an existing mesh model. In another example embodiment, a colorization scheme, a texture, lighting effects, or the like, may be applied to the mesh model in order to convey the sense of the depth of the virtual object in the virtual world.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B illustrate an example embodiment of a target recognition, analysis, and tracking system with a user playing a game.

FIG. 2 illustrates an example embodiment of a capture device that may be used in a target recognition, analysis, and tracking system.

FIG. 3 illustrates an example embodiment of a computing environment that may be used to interpret one or more gestures in a target recognition, analysis, and tracking system.

FIG. 4 illustrates another example embodiment of a computing environment that may be used to interpret one or more gestures in a target recognition, analysis, and tracking system.

FIG. 5 depicts a flow diagram of an example method for conveying a sense of depth by segregating the selected virtual object from other virtual objects in the scene.

FIG. 6 illustrates an example embodiment of the depth image that may be used to convey a sense of depth by segregating the selected virtual object from other virtual objects in the scene.

FIG. 7 illustrates an example embodiment of a model that may be generated based on a human target in a depth image.

FIG. 8 depicts a flow diagram of an example method for conveying a sense of depth by placing orientation cursors on selected virtual objects.

FIG. 9 illustrates an example embodiment of an orientation cursor that may be used to convey a sense of depth to a user.

FIG. 10 depicts a flow diagram of an example method for conveying a sense of depth by extruding a mesh model.

FIG. 11 illustrates an example embodiment of a mesh model that may be used to convey a sense of depth to a user.

FIG. 12 depicts a flow diagram of an example method for conveying a sense of depth by segregating a selected virtual object from other virtual objects in the scene and extruding a mesh model based on the selected virtual object.

### DETAILED DESCRIPTION OF ILLUSTRATIVE EMBODIMENTS

As will be described herein, a user may control an application executing on a computing environment such as a game console, a computer, or the like by performing one or more gestures with an input object. According to one embodiment, the gestures may be received by, for example, a capture device. For example, a capture device may observe, receive, and/or capture images of a scene. In one embodiment, a first image may be analyzed to determine whether one or more objects in the scene correspond to an input object that may be controlled by a user. To determine whether an object in the scene corresponds to an input object, each of the targets, objects, or any part of the scene may be scanned to determine whether an indicator belonging to the input object may be present within the first image. After determining that one or more indicators exist within the first image, the indicators may be grouped together into a cluster that may then be used to generate a first vector that may indicate the orientation of the input object in the captured scene.

Additionally, in one embodiment, after generating the first vector, a second image may then be processed to determine whether one more objects in the scene correspond to a human target such as the user. To determine whether a target or object in the scene may correspond to a human target, each of the targets, objects or any part of the scene may be flood filled and compared to a pattern of a human body model. Each target or object that matches the pattern may then be scanned to generate a model such as a skeletal model, a mesh human model, or the like associated therewith. In an example embodiment, the model may be used to generate a second vector that may indicate the orientation of a body part that may be associated with the input object. For example, the body part may include an arm of the model of the user such that the arm may be used to grasp the input object. Additionally, after generating the model, the model may be analyzed to determine at least one joint that correspond to the body part that may be associated with the input object. The joint may be processed to determine if a relative location of the joint in the scene corresponds to a relative location of the input object. When the relative location of the joints corresponds to the relative location of the input object, a second vector may be generated, based on the joint, that may indicate the orientation of the body part.

The first and/or second vectors may then be track to, for example, to animate a virtual object associated with an avatar, animate an avatar, and/or control various computing applications. Additionally, the first and/or second vector may be provided to a computing environment such that the computing environment may track the first vector, the second vector, and/or a model associated with the vectors. In another embodiment, the computing environment may determine which controls to perform in an application executing on the computer environment based on, for example, the determined angle.

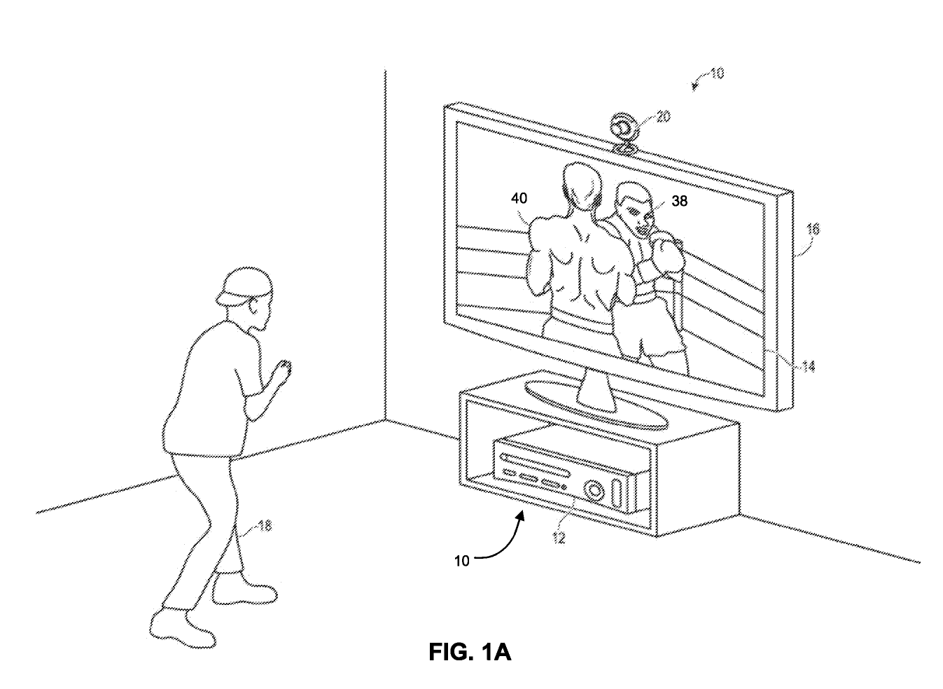

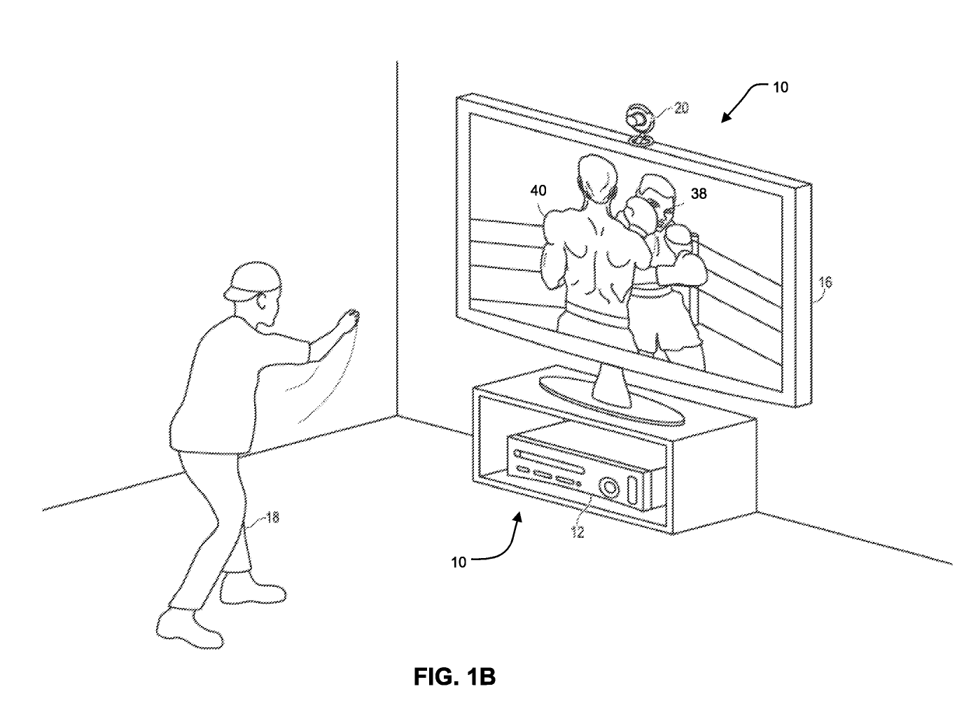

FIGS. 1A and 1B illustrate an example embodiment of a configuration of a target recognition, analysis, and tracking system 10 with a user 18 playing a boxing game. In an example embodiment, the target recognition, analysis, and tracking system 10 may be used to recognize, analyze, and/or track a human target such as the user 18.

As shown in FIG. 1A, the target recognition, analysis, and tracking system 10 may include a computing environment 12. The computing environment 12 may be a computer, a gaming system or console, or the like. According to an example embodiment, the computing environment 12 may include hardware components and/or software components such that the computing environment 12 may be used to execute applications such as gaming applications, non-gaming applications, or the like. In one embodiment, the computing environment 12 may include a processor such as a standardized processor, a specialized processor, a microprocessor, or the like that may execute instructions including, for example, instructions for accessing a capture device, receiving one or more image from the captured device, determining whether one or more objects within one or more images correspond to a human target and/or an input object, or any other suitable instruction, which will be described in more detail below.

As shown in FIG. 1A, the target recognition, analysis, and tracking system 10 may further include a capture device 20. The capture device 20 may be, for example, a camera that may be used to visually monitor one or more users, such as the user 18, such that gestures performed by the one or more users may be captured, analyzed, and tracked to perform one or more controls or actions within an application, as will be described in more detail below. In another embodiment, which will also be described in more detail below, the capture device 20 may further be used to visually monitor one or more input objects, such that gestures performed by the user 18 with the input object may be captured, analyzed, and tracked to perform one or more controls or actions within the application.

According to one embodiment, the target recognition, analysis, and tracking system 10 may be connected to an audiovisual device 16 such as a television, a monitor, a high-definition television (HDTV), or the like that may provide game or application visuals and/or audio to a user such as the user 18. For example, the computing environment 12 may include a video adapter such as a graphics card and/or an audio adapter such as a sound card that may provide audiovisual signals associated with the game application, non-game application, or the like. The audiovisual device 16 may receive the audiovisual signals from the computing environment 12 and may then output the game or application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, or the like.

As shown in FIGS. 1A and 1B, the target recognition, analysis, and tracking system 10 may be used to recognize, analyze, and/or track a human target such as the user 18. For example, the user 18 may be tracked using the capture device 20 such that the movements of user 18 may be interpreted as controls that may be used to affect the application being executed by computing environment 12. Thus, according to one embodiment, the user 18 may move his or her body to control the application.

As shown in FIGS. 1A and 1B, in an example embodiment, the application executing on the computing environment 12 may be a boxing game that the user 18 may be playing. For example, the computing environment 12 may use the audiovisual device 16 to provide a visual representation of a boxing opponent 38 to the user 18. The computing environment 12 may also use the audiovisual device 16 to provide a visual representation of a player avatar 40 that the user 18 may control with his or her movements. For example, as shown in FIG. 1B, the user 18 may throw a punch in physical space to cause the player avatar 40 to throw a punch in game space. Thus, according to an example embodiment, the computing environment 12 and the capture device 20 of the target recognition, analysis, and tracking system 10 may be used to recognize and analyze the punch of the user 18 in physical space such that the punch may be interpreted as a game control of the player avatar 40 in game space.

Other movements by the user 18 may also be interpreted as other controls or actions, such as controls to bob, weave, shuffle, block, jab, or throw a variety of different power punches. Furthermore, some movements may be interpreted as controls that may correspond to actions other than controlling the player avatar 40. For example, the player may use movements to end, pause, or save a game, select a level, view high scores, communicate with a friend, etc. Additionally, a full range of motion of the user 18 may be available, used, and analyzed in any suitable manner to interact with an application.

In example embodiments, the human target such as the user 18 may have an input object. In such embodiments, the user of an electronic game may be holding the input object such that the motions of the player and the input object may be used to adjust and/or control parameters of the game. For example, the motion of a player holding an input object shaped as a racquet may be tracked and utilized for controlling an on-screen racquet in an electronic sports game. In another example embodiment, the motion of a player holding an input object may be tracked and utilized for controlling an on-screen weapon in an electronic combat game.

According to other example embodiments, the target recognition, analysis, and tracking system 10 may further be used to interpret target movements as operating system and/or application controls that are outside the realm of games. For example, virtually any controllable aspect of an operating system and/or application may be controlled by movements of the target such as the user 18.

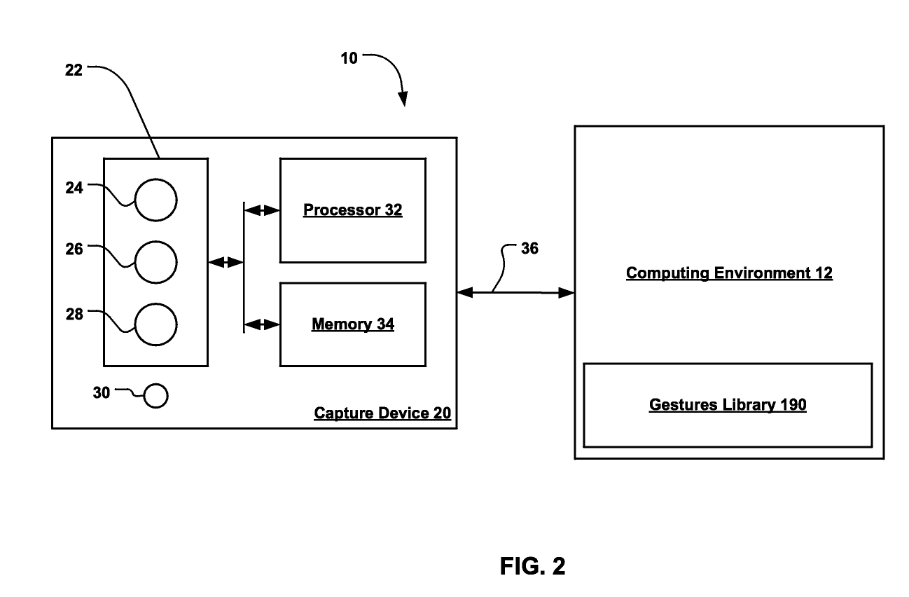

FIG. 2 illustrates an example embodiment of the capture device 20 that may be used in the target recognition, analysis, and tracking system 10. According to an example embodiment, the capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device to a particular location on the targets or objects.

According to another embodiment, the capture device 20 may include two or more physically separated cameras that may view a scene from different angles to obtain visual stereo data that may be resolved to generate depth information.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions including, for example, may execute instructions including, for example, instructions for accessing a capture device, receiving one or more images from the capture device, determining whether one or more objects within the one or more images correspond to a human target and/or an input object, or any other suitable instruction, which will be described in more detail below.

The capture device 20 may further include a memory component 34 that may store the instructions that may be executed by the processor 32, media frames created by the media feed interface 170, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image camera component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide depth information, images captured by, for example, the 3-D camera 26 and/or the RGB camera 28 and/or a model such as a skeletal model that may be generated by the capture device 20 to the computing environment 12 via the communication link 36. The computing environment 12 may then use the depth information, captured images, and/or the model to, for example, animate a virtual object based on an input object, animate an avatar based on an input object, and/or control an application such as a game or word processor. For example, as shown, in FIG. 2, the computing environment 12 may include a gestures library 190. The gestures library 190 may include a collection of gesture filters, each comprising information concerning a gesture that may be performed by the skeletal model (as the user moves). The data captured by the cameras 26, 28 and the capture device 20 in the form of the skeletal model and movements associated with it may be compared to the gesture filters in the gesture library 190 to identify when a user (as represented by the skeletal model) has performed one or more gestures. Those gestures may be associated with various controls of an application. Thus, the computing environment 12 may use the gestures library 190 to interpret movements of the skeletal model and/or an input object and to control an application based on the movements.

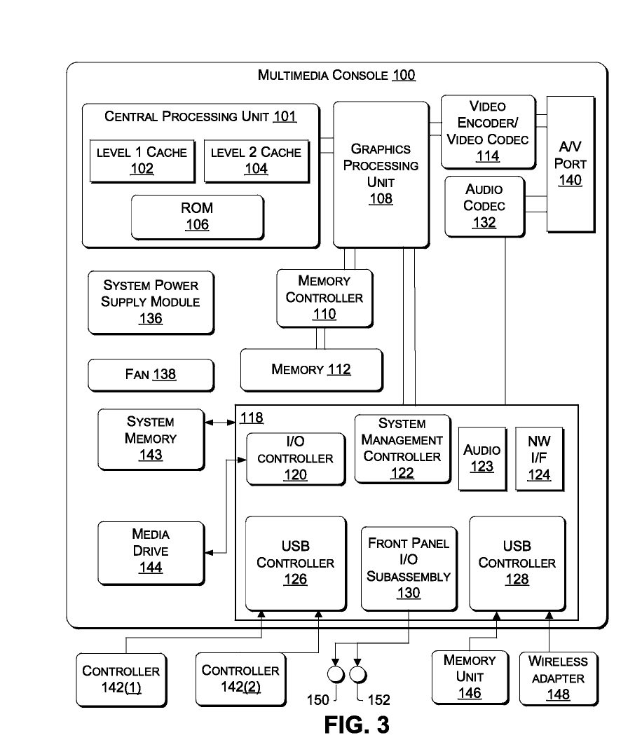

FIG. 3 illustrates an example embodiment of a computing environment that may be used to interpret one or more gestures in a target recognition, analysis, and tracking system. The computing environment such as the computing environment 12 described above with respect to FIGS. 1A-2 may be a multimedia console 100, such as a gaming console. As shown in FIG. 3, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that may be loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data may be carried from the graphics processing unit 108 to the video encoder/video codec 114 via a bus. The video processing pipeline outputs data to an A/V (audio/video) port 140 for transmission to a television or other display. A memory controller 110 may be connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface controller 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 may be provided to store application data that may be loaded during the boot process. A media drive 144 may be provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 may be connected to the I/O controller 120 via a bus, such as a Serial ATA bus or other high-speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data may be carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media included within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface controller 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably may be large enough to include the launch kernel, concurrent system applications and drivers. The CPU reservation may be preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface may be used by the concurrent system application, it may be preferable to use a resolution independent of application resolution. A scaler may be used to set this resolution such that the need to change frequency and cause a TV resynch may be eliminated.

After the multimedia console 100 boots and system resources are reserved, concurrent system applications execute to provide system functionalities. The system functionalities are encapsulated in a set of system applications that execute within the reserved system resources previously described. The operating system kernel identifies threads that are system application threads versus gaming application threads. The system applications are preferably scheduled to run on the CPU 101 at predetermined times and intervals in order to provide a consistent system resource view to the application. The scheduling may be to minimize cache disruption for the gaming application running on the console.

When a concurrent system application requires audio, audio processing may be scheduled asynchronously to the gaming application due to time sensitivity. A multimedia console application manager (described below) controls the gaming application audio level (e.g., mute, attenuate) when system applications are active.

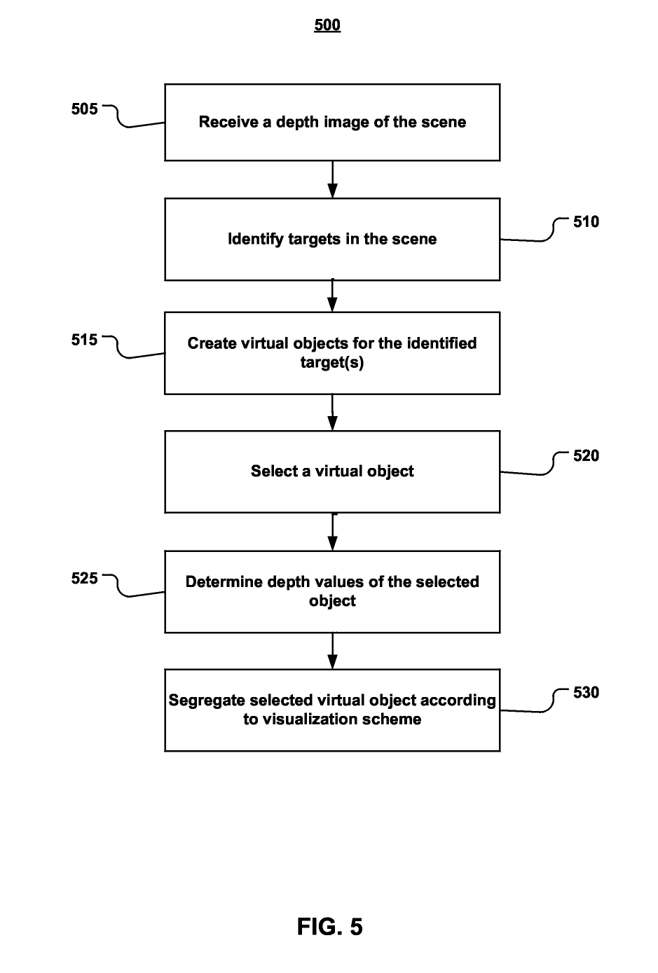

Input devices (e.g., peripheral controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The three-dimensional (3-D) camera 26, and an RGB camera 28, the capture device 20, and the input object 55, as shown in FIG. 5, may define additional input devices for the multimedia console 100.

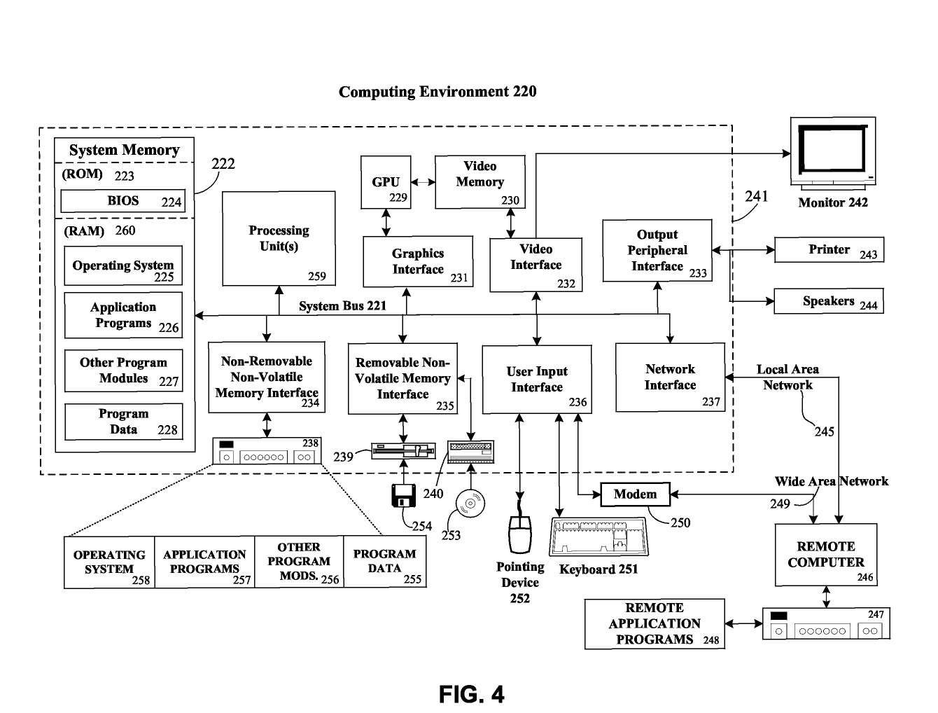

FIG. 4 illustrates another example embodiment of a computing environment 12 that may be the computing environment 12 shown in FIGS. 1A-2 used to interpret one or more gestures in a target recognition, analysis, and tracking system. The computing system environment 220 is only one example of a suitable computing environment and is not intended to suggest any limitation as to the scope of use or functionality of the presently disclosed subject matter. Neither should the computing environment 12 be interpreted as having any dependency or requirement relating to any one or combination of components illustrated in the exemplary operating environment 220. In some embodiments, the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general-purpose processing unit, memory, etc., configured by software instructions that embody logic operable to perform function(s). In example embodiments where circuitry includes a combination of hardware and software, an implementer may write source code embodying logic and the source code can be compiled into machine-readable code that can be processed by the general-purpose processing unit. Since one skilled in the art can appreciate that the state of the art has evolved to a point where there may be little difference between hardware, software, or a combination of hardware/software, the selection of hardware versus software to effectuate specific functions may be a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation may be one of design choice and left to the implementer.

In FIG. 4, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), including the basic routines that help to transfer information between elements within computer 241, such as during start-up, may be typically stored in ROM 223. RAM 260 typically includes data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 may be typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 226, other program modules 227, and program data 228. Note that these components can either be the same as or different from operating system 225, application programs 226, other program modules 227, and program data 228. Operating system 225, application programs 226, other program modules 227, and program data 228 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that may be coupled to the system bus, but may be connected by other interface and bus structures, such as a parallel port, game port or a universal serial bus (USB). The 3-D camera 26, the RGB camera 28, capture device 20, and input object 55, as shown in FIG. 5, may define additional input devices for the multimedia console 100. A monitor 242 or other type of display device may also be connected to the system bus 221 via an interface, such as a video interface 232. In addition to the monitor, computers may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 4. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 may be connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates remote application programs 248 as residing on memory device 247. It will be appreciated that the network connections shown are exemplary and other means of establishing a communications link between the computers may be used.

FIG. 5 illustrates a flow diagram of an example method for conveying a sense of depth by segregating a selected virtual object from other virtual objects in the scene. The example method may be implemented using, for example, the capture device 20 and/or the computing environment 12 of the target recognition, analysis, and tracking system 10 described with respect to FIGS. 1A-4. In an example embodiment, the method may take the form of program code (i.e., instructions) that may be executed by, for example, the capture device 20 and/or the computing environment 12 of the target recognition, analysis, and tracking system 10 described with respect to FIGS. 1A-4.

According to an example embodiment, at 505, the target recognition, analysis, and tracking system may receive the depth image. For example, the target recognition, analysis, and tracking system may include a capture device such as the capture device 20 described above with respect to FIGS. 1A-2. The capture device may capture or may observe the scene that may include one or more targets. In an example embodiment, the capture device may be a depth camera configured to obtain a depth image of the scene using any suitable techniques such as time-of-flight-analysis, structured light analysis, stereo vision analysis, or the like.

According to an example embodiment, the depth image may be a plurality of observed pixels where each observed pixel has an observed depth value. For example, the depth image may include a two-dimensional (2-D) pixel area of the captured scene where each pixel in the 2-D pixel area may represent a depth value such as a length or distance in, for example, centimeters, millimeters, or the like of an object or target in the captured scene from the capture device.

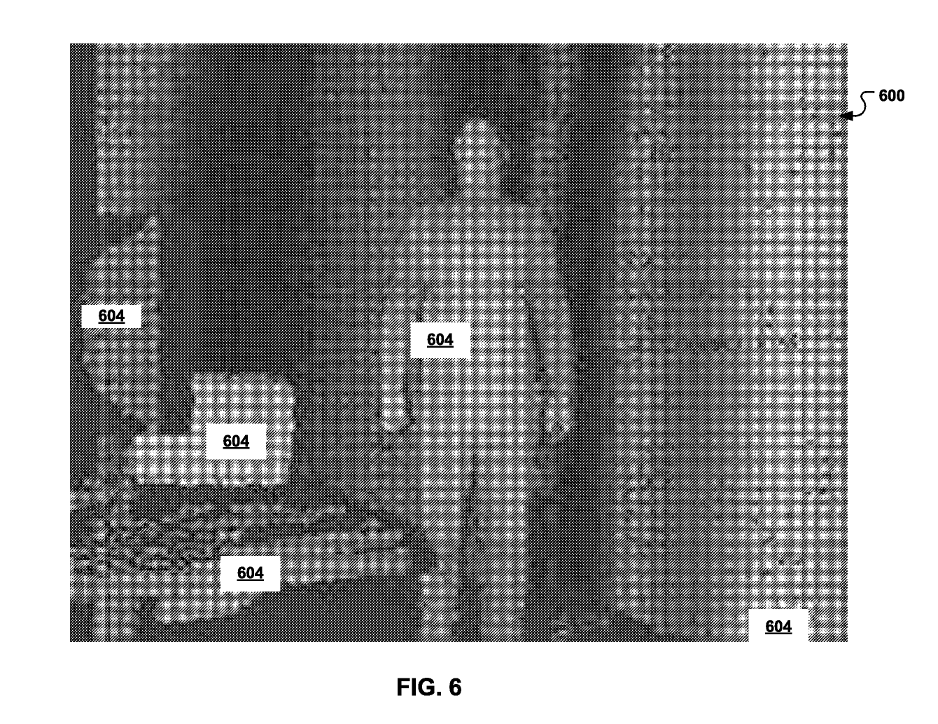

FIG. 6 illustrates an example embodiment of a depth image 600 that may be received at 505. According to an example embodiment, the depth image 600 may be an image or a frame of a scene that may be captured by, for example, the 3-D camera 26 and/or the RGB camera 28 of the capture device 20 described above with respect to FIG. 2. As shown in FIG. 6, the depth image 600 may include one or more targets 604 such as a human target, a chair, a table, a wall, or the like in the captured scene. As described above, the depth image 600 may include a plurality of observed pixels where each observed pixel has an observed depth value associated therewith. For example, the depth image 600 may include a two-dimensional (2-D) pixel area of the captured scene where each pixel in the 2-D pixel area may represent a depth value such as a length or distance in, for example, centimeters, millimeters, or the like of a target or object in the captured scene from the capture device.

Referring back to FIG. 5, at 510 the target recognition, analysis, and tracking system may identify targets in the scene. In an example embodiment, targets in the scene may be identified by defining the boundaries of objects. In defining the boundaries of objects, the depth image may be analyzed to determine pixels that are of substantially the same relative depth. Those pixels may then be grouped in such a way as to form a boundary that may further be used to define a virtual object. For example, after analyzing the depth image a number of pixels at a substantially related depth may be grouped together to indicate the boundaries of a person that may be standing in front of a wall.

At 515, the target recognition, analysis, and tracking system may create virtual objects for the identified target. A virtual object may be an avatar, a model, an image, a mesh model, or the like. In one embodiment, virtual objects may be created in the 3-D virtual world to represent targets in the scene. For example, a model may be used to track and display the movements of a human user in the scene.

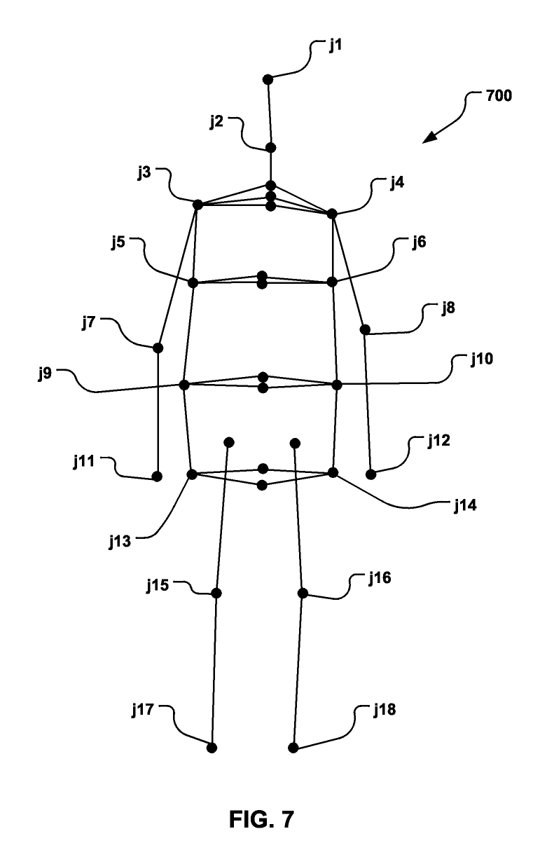

FIG. 7 illustrates an example embodiment of a model that may be used to track and display the movements of a human user. According to an example embodiment, the model may include one or more data structures that may represent, for example, the human target found within a depth image, such as the depth image 600. Each body part may be characterized as a mathematical vector defining joints and bones of the model. For example, joints j7 and j11 may be characterized as a vector that may indicate the orientation of the arm that a user, such as the user 18, may use to grasp an input object, such as the input object 55.

As shown in FIG. 7, the model may include one or more joints j1-j18. According to an example embodiment, each of the joints j1-j18 may enable one or more body parts, defined between the joints, to move relative to one or more other body parts. For example, a model representing a human target may include a plurality of rigid and/or deformable body parts that may be defined by one or more structural members such as “bones” with the joints j1-j18 located at the intersection of adjacent bones. The joints j1-j18 may enable various body parts associated with the bones and joints j1-j18 to move independently of each other. For example, the bone defined between the joints j7 and j11, shown in FIG. 7, corresponds to a forearm that may be moved independent of, for example, the bone defined between joints j15 and j17 that corresponds to a calf.

Referring back to FIG. 5, in another example embodiment depth values taken from pixels associated with the target in the depth image may be stored as part of the virtual object. For example, the target recognition, analysis, and tracking system may analyze the target boundaries within the depth image, determine the pixels within those boundaries, determine the depth values associated with those pixels, and store those depth values within the virtual object. This may be done, for example, to avoid having to determine the depth values of the virtual object later.

At 520 the target recognition, analysis, and tracking system may select one or more virtual objects in the scene. In one embodiment, the user may select the virtual objects. In another embodiment, one or more virtual objects may be selected by an application, such as a video game, an operating system, a gesture library, or the like. For example, a videogame application may select a virtual object that corresponds to a user and/or a virtual object that corresponds to a tennis racquet being held by the user.

At 525 the target recognition, analysis, and tracking system may determine the depth values of the selected virtual object. In an example embodiment, depth values of the selected virtual object may be determined by retrieving the stored values from the selected virtual object. In another example embodiment, depth values may be determined from the depth image. In using the depth image, pixels within the boundaries that correspond to the selected virtual object may be identified. Once identified, depth values may be determined for each of the pixels.

At 530 the target recognition, analysis, and tracking system may segregate the selected virtual object according to a visualization scheme to convey a sense of depth. In an example embodiment, the selected virtual object may be segregated by coloring the pixels of the selected virtual object according to a colorization scheme. The colorization scheme may be a graphical representation of depth data were the depth values of the selected virtual object are represented by colors. By using a colorization scheme, the target recognition, analysis, and tracking system may convey a sense of the depth the selected virtual object may have within the 3-D virtual world and/or the scene. The colors used in the colorization scheme may comprise shades of a single color, a range of colors, black and white, or the like. For example, a range of colors may be selected to represent the distance a selected virtual object may have from a user in the 3-D virtual world.

FIG. 6 illustrates an example embodiment of a colorization scheme. In an example embodiment, the depth image 600 may be colorized such that different colors of the pixels of the depth image correspond to and/or visually depict different distances of the targets 604 from the capture device. For example, according to one embodiment, the pixels associated with a target closest to the capture device may be colored with shades of red and/or orange in the depth image whereas the pixels associated with a target further away may be colored with shades of green and/or blue in the depth image.

In another example embodiment, the target recognition, analysis, and tracking system may segregate the selected virtual object by coloring the pixels that belong to the selected virtual object according to images received by an RGB camera. A RGB image may be received from the RGB camera and may be applied to the selected virtual object. After the RGB image is applied, the RGB image may be modified according to a colorization scheme such as one of the colorization schemes described above. For example, the selected virtual object that corresponds to a tennis racquet in the scene may be colored with an RGB image of the tennis racquet and modified with a colorization scheme to indicate distance between the racquet and the user in the 3-D virtual world. Modifying the RGB image with the colorization scheme may occur by blending several images, making the RGB image more transparent, applying a tint to the RGB image, or the like.

In another example embodiment, the target recognition, analysis, and tracking system may segregate the selected virtual object by outlining the boundaries of the selected virtual object to distinguish it. The boundaries of the selected virtual object may be determined from the 3-D virtual world, the depth image, the scene, or the like. After boundaries of the selected virtual object are determined, correlating depth values for pixels those boundaries may be determined. The depth values may then be used to color the boundaries of the selected virtual object according to a colorization scheme such as the colorization schemes described above. For example, a virtual object of a tennis racquet may be outlined in bright yellow to indicate that the tennis racquet may be near the user in the 3-D virtual world and/or the scene.

In another example embodiment, the target recognition, analysis, and tracking system may segregate the selected virtual object by manipulating a mesh associated with the selected virtual object. A mesh model that may be associated with the selected virtual object may be retrieved and/or created. The mesh model may then be colored according to a colorization scheme such as one of the colorization schemes described above. In another example embodiment, lighting effects, such as shadows, highlights, or the like may be applied to the virtual object and/or the mesh model.

In another example embodiment, an RGB image may be received from the RGB camera and may be applied to the mesh model. The RGB image may then be modified according to a colorization scheme such as the colorization scheme previously described. For example, a selected virtual object that corresponds to a tennis racquet in the scene may be colored with an RGB image of the tennis racquet and modified according to a colorization scheme to indicate the distance between the racquet and the user in the 3-D virtual world. Modifying the RGB image with the colorization scheme may occur by blending several images, making the RGB image more transparent, applying a tint to the RGB image, or the like.

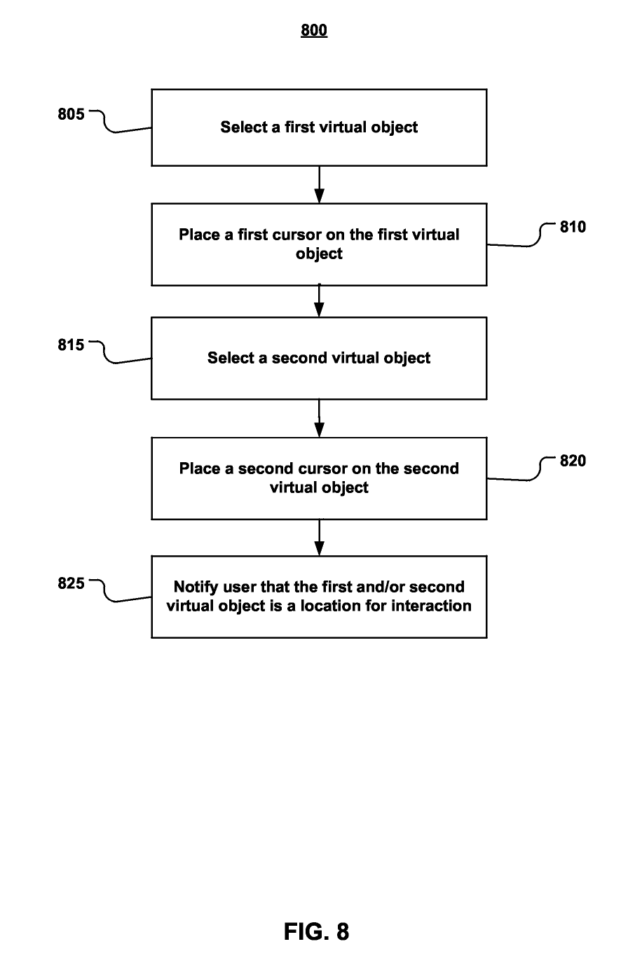

FIG. 8 illustrates a flow diagram of an example method for conveying a sense of depth by placing orientation cursors on selected virtual objects. The example method may be implemented using, for example, the capture device 20 and/or the computing environment 12 of the target recognition, analysis, and tracking system 10 described with respect to FIGS. 1A-4. In an example embodiment, the method may take the form of program code (i.e., instructions) that may be executed by, for example, the capture device 20 and/or the computing environment 12 of the target recognition, analysis, and tracking system 10 described with respect to FIGS. 1A-4.

At 805 the target recognition, analysis, and tracking system may select a first virtual object in the 3-D virtual world and/or the scene. In one embodiment, the use may select the first virtual object. In another embodiment, the first virtual object may be selected by an application, such as a video game, an operating system, a gesture library a gesture, or the like. For example, a videogame application running on the computing virtual world may select the virtual object that corresponds to tennis racquet being held by the user as the first virtual object.

At 810 the target recognition, analysis, and tracking system may place a first cursor on the first virtual object. The first cursor placed on the first virtual object may be a shape, a color, a text string, or the like and may indicate the position of the first virtual object in the 3-D virtual world. In indicating the position of the first virtual object in the 3-D virtual world, the first cursor may change in size, location, shape, color, text, or the like. For example, as a tennis racquet being held by the user is swung, the cursor associated with a tennis racquet may decrease in size to indicate that the racquet may be moving further away from the user in the 3-D virtual world.

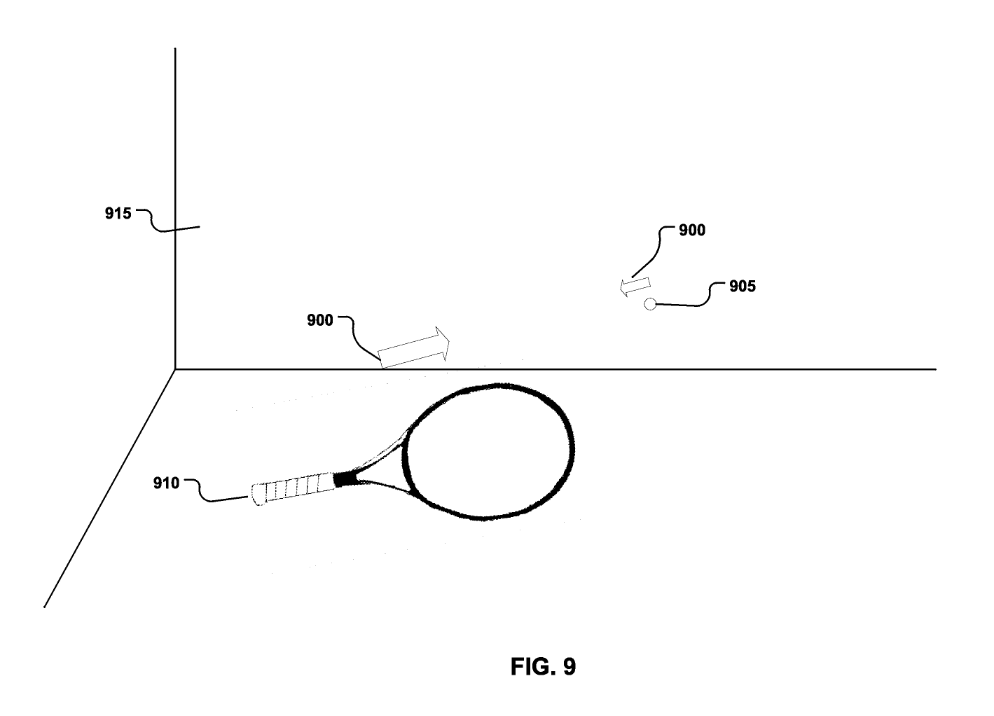

FIG. 9 illustrates an example embodiment of an orientation cursor that may be used to convey a sense of depth to a user. According to an example embodiment, the virtual cursor, such as the virtual cursor 900, may be placed on one or more virtual objects. For example, the virtual cursor 900 may be placed on the virtual object 910, which is illustrated as a tennis racquet. The virtual cursor may change in size, shape, orientation, color, or the like, to indicate the position of a virtual object within a 3-D virtual world, or the scene. In one embodiment, the virtual cursor may indicate the position of the virtual object 910 and/or the virtual object 905 in relation to the user. For example, as a tennis racquet is swung by the user, the cursor associated with the tennis racquet may decrease in size to indicate that the tennis racquet may be moving further away from the user in the 3-D virtual world.

In another embodiment, a virtual cursor may indicate the position of a first virtual, such as the virtual object 910, in relation to a second virtual object, such as the virtual object 905. For example, the virtual cursors 900 and 901 may point to each other to indicate a location in the 3-D virtual world where the two virtual objects may interact. Using the virtual cursor(s) as guidance, a user may move one virtual object towards the other virtual object. When the two virtual objects make contact in, the virtual cursor(s) may change in size, shape, orientation, color, or the like, to indicate that interaction has occurred, or will occur.

Referring back to FIG. 8, at 815 the target recognition, analysis, and tracking system may select a second virtual object in the 3-D virtual world and/or the scene. In one embodiment, the use may select the second virtual object. In another embodiment, the second virtual object may be selected by an application, such as a video game, an operating system, a gesture library a gesture, or the like. For example, a videogame application running on the computing environment may select the virtual object that may correspond to a tennis ball in the 3-D virtual world.

At 820 the target recognition, analysis, and tracking system may place a second cursor on the second virtual object. The second cursor placed on the second virtual object may be a shape, a color, a text string, or the like and may indicate the position of the second virtual object in the 3-D virtual world. In indicating the position of the second virtual object in the 3-D virtual world, the second cursor may change in size, location, shape, color, text, or the like. For example, as a tennis ball approaches the user in a 3-D virtual world, the cursor associated with a tennis ball may increase in size to indicate that the tennis ball may be moving closer to the user in a 3-D virtual world.

At 825 the target recognition, analysis, and tracking system may notify the user that the first and/or second virtual objects are in proper place for interaction. As the first and/or second virtual objects move around the 3-D virtual world, the first and/or second virtual objects may become located in an area where user interaction, such as controlling the virtual object, is possible. For example, in a videogame application a user may interact with a tennis ball that may be near. To notify the user that the first and/or second virtual object(s) are in a proper place for interaction, the first and/or second cursor(s) may be modified. In modifying the first and/or second cursor(s), the first and/or second cursor(s) may change in size, location, shape, color, text, or the like. For example, a user holding a tennis racquet may be able to hit a virtual tennis ball when the cursors associated with the tennis racquet and the tennis ball are of the same size and color.

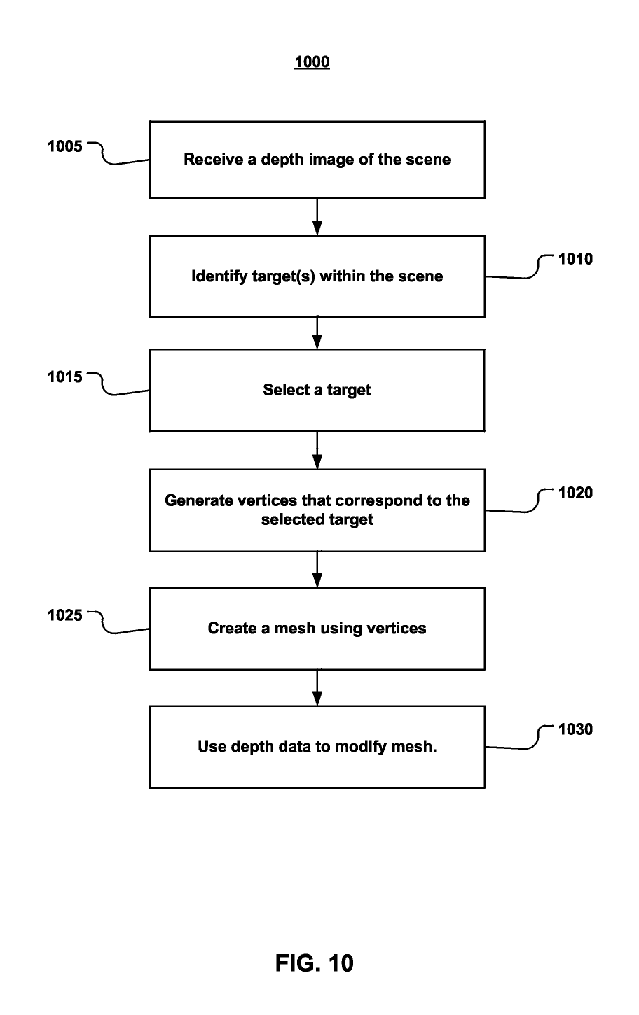

FIG. 10, illustrates a flow diagram of an example method for conveying a sense of depth by extruding a mesh model. The example method may be implemented using, for example, the capture device 20 and/or the computing environment 12 of the target recognition, analysis, and tracking system 10 described with respect to FIGS. 1A-4. In an example embodiment, the method may take the form of program code (i.e., instructions) that may be executed by, for example, the capture device 20 and/or the computing environment 12 of the target recognition, analysis, and tracking system 10 described with respect to FIGS. 1A-4.

According to an example embodiment, at 1005, the target recognition, analysis, and tracking system may receive the depth image. For example, the target recognition, analysis, and tracking system may include a capture device such as the capture device 20 described above with respect to FIGS. 1A-2. The capture device may capture or may observe the scene that may include one or more targets. In an example embodiment, the capture device may be a depth camera that may be configured to obtain a depth image of the scene using any suitable techniques such as time-of-flight-analysis, structured light analysis, stereo vision analysis, or the like. According to an example embodiment, the depth image may be the depth image illustrated by FIG. 6.

At 1010 the target recognition, analysis, and tracking system may identify targets in the scene. In an example embodiment, targets in the scene may be identified by defining boundaries. In defining boundaries, the depth image may be analyzed to determine pixels that are of substantially the same relative depth. Those pixels may be grouped in such a way as to form a boundary that may define a virtual object. For example, after analyzing the depth image a number of pixels at a substantially related depth may be grouped together to indicate the boundaries of a person that may be standing in front of a wall.

At 1015 the target recognition, analysis, and tracking system may select a target. In one embodiment, the user may select the target. In another embodiment, the target may be selected by an application, such as a video game, an operating system, a gesture library a gesture, or the like. For example, a videogame application running on the computing virtual world may select a target that corresponds to a user and/or a target that corresponds to a tennis racquet being held by the user.

At 1020 the target recognition, analysis, and tracking system may generate vertices based on pixels that correspond to the selected target. In an example embodiment, vertices may be identified within the target that may be used to create a model. In identifying vertices, the depth image may be analyzed to determine pixels that are of substantially the same relative depth. Those pixels may be grouped in such a way as to form a vertex. When several vertices are found, those vertices may be used in such a way as to define boundaries of the target. For example, after analyzing the depth image a number of pixels at a substantially related depth may be grouped together to form vertices that may represent features of a person, those vertices may then be used to indicate the boundaries of the person.

At 1025 the target recognition, analysis, and tracking system may create a mesh model using the generated vertices. In an example embodiment, after the vertices are generated, the vertices may be connected in such a way as to create a mesh model. The mesh model may then be used to create virtual objects in 3-D virtual world that represent objects in the scene. For example, the mesh model may be used to track user movements. In another example embodiment, the mesh model may be created in such as a way that depth values may be stored as part of the mesh model. The depth values may be stored by extruding the mesh model, for example. Extruding the mesh model may occur by moving vertices forward or backward in the depth field according to the depth value associated with the vertices. Extrusion may be performed in such a way that the mesh model may create a 3-D representation of the target, for example.

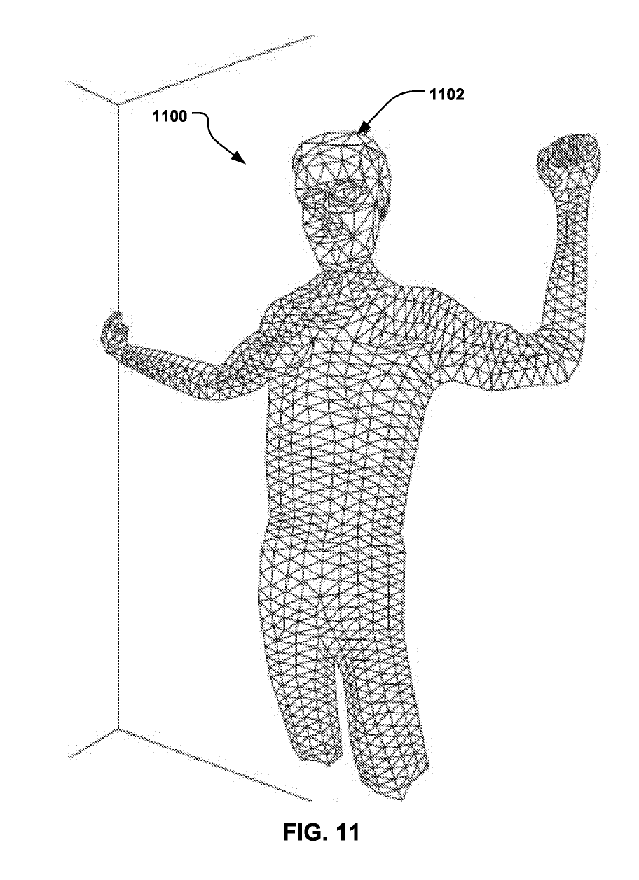

FIG. 11 illustrates an example embodiment of a mesh model that may be used to convey a sense of depth to a user. According to an example embodiment, the model 1100 may include one or more data structures that may represent, for example, the human target described above with respect to FIG. 10, as a 3-D model. For example, the model 1100 may include a wireframe mesh that may have hierarchies of rigid polygonal meshes, one or more deformable meshes, or any combination of thereof. According to an example embodiment, the mesh may include bending limits at each polygonal edge. As shown in FIG. 11, the model 1100 may include a plurality of triangles (e.g., triangle 1102) arranged in a mesh that defines the shape of the body model including one or more body parts.

Referring back to FIG. 10, at 1030 the target recognition, analysis, and tracking system may use depth data from the depth image to modify the mesh model. A mesh model that may be associated with the selected target may be retrieved and/or created. After the mesh model has been retrieved and/or created, a colorization scheme such as one of the colorization schemes described above may be applied to the mesh model. In another example embodiment, lighting effects, such as shadows, highlights, or the like may be applied to the virtual object and/or the mesh model.

In another example embodiment, an RGB image may be received from the RGB camera and may be applied to the mesh model. After the RGB image is applied to the mesh model, the RGB image may be modified according to a colorization scheme such as the colorization scheme described above. For example, a selected virtual object that may correspond to a tennis racquet in the scene may be colored with an RGB image of the tennis racquet and may be modified with a colorization scheme to indicate distance between the racquet and the user. Modifying the RGB image with the colorization scheme may occur by blending several images, making the RGB image more transparent, applying a tint to the RGB image, or the like.

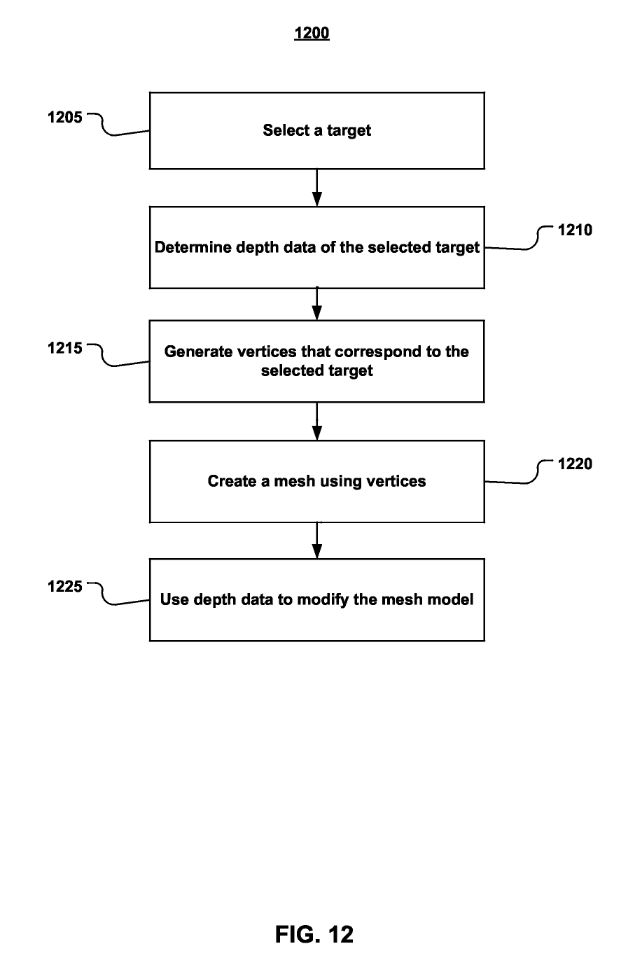

FIG. 12 illustrates a flow diagram of an example method for conveying a sense of depth by segregating a selected target from other targets objects in the scene and extruding a mesh model based on the selected target. The example method may be implemented using, for example, the capture device 20 and/or the computing environment 12 of the target recognition, analysis, and tracking system 10 described with respect to FIGS. 1A-4. In an example embodiment, the method may take the form of program code (i.e., instructions) that may be executed by, for example, the capture device 20 and/or the computing environment 12 of the target recognition, analysis, and tracking system 10 described with respect to FIGS. 1A-4.

At 1205 the target recognition, analysis, and tracking system may select a target in the scene. In one embodiment, the user may select the target. In another embodiment, the target may be selected by an application, such as a video game, an operating system, a gesture library a gesture, or the like. For example, a videogame application running on the computing virtual world may select a target that corresponds to a user.

At 1210 the target recognition, analysis, and tracking system may determine the boundaries of the selected target. In an example embodiment the target recognition, analysis, and tracking system may identify the selected target in a depth image by defining the boundaries of the selected target. For example, the depth image may be analyzed to determine pixels that are of substantially the same relative depth. Those pixels may be grouped in such a way as to form a boundary that may further be used to define the selected target within the depth image. For example, after analyzing the depth image, a number of pixels at a substantially related depth may be grouped together to indicate the boundaries of a person that may be standing in front of a wall.

At 1215 the target recognition, analysis, and tracking system may generate vertices based on the boundaries that correspond to the selected target. In an example embodiment, points within the boundaries may be used to create a model. For example, depth image pixels within the boundaries may be analyzed to determine pixels that are of substantially the same relative depth. Those pixels may be grouped in such a way as to generate a vertex, or vertices.

At 1220 the target recognition, analysis, and tracking system may create a mesh model using the generated vertices. In an example embodiment, after the vertices are generated, the vertices may be connected in such a way as to create a mesh model, such as the mesh model illustrated in FIG. 11. The mesh model may then be used to create virtual objects in 3-D virtual world that represent objects in the scene. For example, the mesh model may be used to track user movements. In another example embodiment, the mesh model may be created in such a way that depth values may be stored as part of the mesh model. The depth values may be stored by extruding the mesh model, for example. Extruding the mesh model may occur by moving vertices forward or backward in the depth field according to the depth value associated with the vertices. Extrusion may be performed in such a way that the mesh model may create a 3-D representation of the target.

At 1225 the target recognition, analysis, and tracking system may use depth data from the depth image to modify the mesh model. In an example embodiment, depth values may be used to extrude the mesh model by moving vertices forward or backward. In another example embodiment, a colorization scheme such as one of the colorization schemes described above may be applied to the mesh model. In another example embodiment, lighting effects, such as shadows, highlights, or the like may be applied to the virtual object and/or the mesh model.

In another example embodiment, an RGB image may be received from the RGB camera and may be applied to the mesh model. After the RGB image is applied to the mesh model, the RGB image may then be modified according to a colorization scheme such as the colorization scheme described above. For example, the mesh model may correspond to a tennis racquet in the scene and may be colored according to a RGB image of the tennis racquet and modified according to a colorization scheme that indicates the distance between the racquet and the user in the 3-D world, or the scene. Modifying the RGB image with the colorization scheme may occur by blending several images, making the RGB image more transparent, applying a tint to the RGB image, or the like.

What is claimed:

1. A method for conveying a visual sense of depth, the method comprising:
receiving a depth image of a scene;
determining depth values for one or more targets in the scene; and
rendering a visual depiction of the one or more targets in the scene according to a visualization scheme, the visualization scheme using the depth values determined for the one or more targets.

2. The method of claim 1 further comprising grouping depth image pixels that are of the same relative depth to define boundary pixels.

3. The method of claim 2 further comprising analyzing the boundary pixels to identify the one or more targets in the scene.

4. The method of claim 1, wherein the visualization scheme comprises a colorization scheme that represents a distance between the one or more targets and a user.

5. The method of claim 1, wherein rendering the visual depiction of the one or more targets further comprises:
generating a virtual model for at least one of the one or more targets; and
coloring the virtual model according to a colorization scheme, the colorization scheme representing a distance between the one or more targets and a user.

6. The method of claim 1 further comprising:
receiving an RGB image of the one or more targets in the scene; and
applying the RGB image to the one or more targets in the scene.

7. The method of claim 6, wherein the rendering the visual depiction of the one or more targets in the scene comprises modifying the RGB image with a colorization scheme that represents a distance between the one or more targets and a user.

8. The method of claim 1 further comprising:
selecting a first target and a second target from the one or more targets in the scene;
generating a first cursor for the first target;
generating a second cursor for the second target; and
rendering the first cursor and the second cursor according to the visualization scheme.

9. A system for conveying a sense of depth, the system comprising:
a processor, the processor for executing computer executable instructions, the computer executable instructions comprising instructions for:
receiving a depth image of a scene;
identifying a target within the scene;
generating vertices that correspond to the target based on the depth image; and
generating a mesh model to represent the target using the vertices.

10. The system of claim 9, wherein the computer executable instructions for generating the vertices comprises:
grouping pixels grouping pixels in the depth image that are of the same relative depth to create boundary pixels;
defining the vertices of the mesh model according to the boundary pixels;

11. The system of claim 9, wherein the computer executable instructions for generating the mesh model using the vertices comprises using vectors to connect the vertices.

12. The system of claim 9, wherein the computer executable instructions further comprise using depth data from the depth image to modify the mesh model.

13. The system of claim 9, wherein the computer executable instructions further comprise:
determining depth data for the target from the depth image; and
extruding the mesh model by moving the vertices based on the depth data.

14. The system of claim 9, wherein the computer executable instructions further comprise rendering the mesh model according a visualization scheme, the visualization scheme using depth values determined for the target.

15. A computer-readable storage medium having stored thereon computer executable instructions for conveying a sense of depth in a three-dimensional virtual world, the computer executable instructions comprising instructions for:
identifying a target within a depth image of a scene;
generating vertices that correspond to the target identified within the scene; and
rendering a visual depiction of the target according to a visualization scheme, the visualization scheme using the vertices.

16. The computer-readable storage medium of claim 15, wherein the computer executable instructions for rending the visual depiction of the target comprise generating a mesh model using the vertices.

17. The computer-readable storage medium of claim 15, wherein the visualization scheme comprises a colorization scheme that represents a distance between the target and a user.

18. The computer-readable storage medium of claim 15, wherein the computer executable instructions further comprising:
receiving an RGB image of the target; and
applying the RGB image to the target.

19. The computer-readable storage medium of claim 15, wherein generating the vertices comprises grouping pixels in the depth image that are of the same relative depth.

20. The computer-readable storage medium of claim 15, wherein the computer executable instructions further comprise:
generating an orientation cursor for the target, the orientation cursor conveying an orientation of the target; and
rendering the orientation cursor according to the visual scheme.
